(19) United States
(12) Patent Application Publication
(10) Pub. No.: US 2007/0167056 A1
(43) Pub. Date: Jul. 19, 2007

(54) Multi-layer printed circuit board, and method for detecting errors in laminating order of layers thereof

(75) Inventor: Ying-Chih Shen, Tai-Li City (TW)

Correspondence Address: BANNER & WITCOFF, LTD., 1100 13th STREET, N.W., SUITE 1200, WASHINGTON, DC, 20005-4051, US

(73) Assignee: Universal Scientific Industrial Co., LTD., Tsao-Tun Chen (TW)

(21) Appl. No.: 11/332,301

(22) Filed: Jan. 17, 2006

(51) Int. Cl. H01R 13/62

(52) U.S. Cl. 439/262

(57) ABSTRACT

A method for detecting errors in laminating order of layers of a multi-layer printed circuit board, includes: preparing a multi-layer printed circuit board including a plurality of conductive layers and a plurality of dielectric layers disposed alternately with the conductive layers; defining a conductive line, a conductive reference surface, and a through-hole on three adjacent ones of the conductive layers in such a manner that the conductive line, the conductive reference surface, and the through-hole are aligned in a normal direction relative to the multi-layer printed circuit board; coupling a Time Domain Reflectometer (TDR) to the conductive line and the conductive reference surface so as to form a signal transmission line; and sending a pulsed signal into the conductive line through the TDR so as to measure characteristic impedance of the signal transmission line.

### BACKGROUND OF THE INVENTION

1. Field of the Invention

This invention relates to a method for detecting errors in the laminating order of layers of a multi-layer printed circuit board, and to a multi-layer printed circuit board provided with a detecting unit.

2. Description of the Related Art

Referring to FIG. 1, a conventional multi-layer printed circuit board includes a conductive unit 5 and an insulating unit 6. The conductive unit 5 includes at least three conductive layers 51 made from copper foils, and is used for signal and power transmission. The insulating unit 6 includes at least two translucent insulating layers 61 disposed to alternate with the conductive layers 51. In general, the multi-layer printed circuit board is denominated according to the number of the conductive layers 51. For example, in FIG. 1, the multi-layer printed circuit board is referred to as a six-layer printed circuit board.

When the laminating order of the layers of the printed circuit board is incorrect, the relationship between a conductive line anda conductive reference layer is changed, thereby resulting in drift in the characteristic impedance, electromagnetic interference, etc. As such, the printed circuit board thus formed cannot be used and is subsequently discarded.

In order to ensure accuracy of the laminating order, methods for detecting errors in the laminating order of a printed circuit board have been proposed. Referring to FIG. 2, Taiwanese Patent Publication No. 540963 discloses detecting means for detecting accuracy of the laminating order of a printed circuit board. A printed circuit board including a conductive unit 5 having six conductive layers 51 and an insulating unit 6 having five insulating layers 61 is used as an example in this application. The detecting means includes two windows 10 and two detecting members 30 offset from each other. The two windows 10 are respectively disposed on the outermost conductive layers 51, and each has two viewing areas 12, 14. Each of the detecting members 30 includes an upper covering area 31, a detecting mark 33, and a lower covering area 35. The upper and lower covering areas 31, 35 are offset from each other.

When the laminating order is correct, as shown in FIG. 3, halves of the detecting marks 33 are respectively covered by the upper covering areas 31 (or the lower covering areas 35 depending on the observing direction). On the contrary, when the laminating order is incorrect, at least one of the detecting marks 33 is fully covered or not covered by the respective upper and lower covering areas 31, 35.

The detecting method mentioned above is conducted by illuminating the printed circuit board and observing the detecting marks 33 from the windows 10 through the translucent insulating layers 61. However, when the number of the layers of the printed circuit board is increased, observation of the detecting marks 33 becomes more difficult.

In addition, Taiwanese Patent Publication No. 565104 discloses an apparatus for detecting errors in the laminating order of a multi-layer printed circuit board. The apparatus includes a recognizing device and a thickness-detectingdevice. The recognizing device is used to recognize recognizing marks on conductive layers and insulating layers, whereas the thickness-detectingdevice is used to determine the laminated thickness of the printed circuit board. Whether or not the laminating order is correct can be determined by virtue of the recognizing marks and laminated thickness detected by the apparatus. However, because of the need to purchase the detecting apparatus when detecting the laminating order of a multi-layer printed circuit board, higher manufacturing costs are incurred. Moreover, as technology advances in the field of printed circuit boards, the scale of the multi-layer printed circuit boards is getting smaller. Hence, the requirement for precision of such detecting apparatus becomes stricter.

### SUMMARY OF THE INVENTION

Therefore, the object of the present invention is to provide a method for detecting errors in laminating order of layers of a multi-layer printed circuit board that can overcome the aforesaid drawbacks of the prior art.

Another object of the present invention is to provide a multi-layer printed circuit board having a detecting unit that can facilitate detection of errors in laminating order of layers thereof.

According to one aspect of this invention, there is provided a method for detecting errors in laminating order of layers of a multi-layer printed circuit board, comprising: preparing a multi-layer printed circuit board including a plurality of conductive layers and a plurality of dielectric layers disposed alternately with the conductive layers; defining a conductive line, a conductive reference surface, and a through-hole respectively on three adjacent ones of the conductive layers in such a manner that the conductive line, the conductive reference surface, and the through-hole are aligned in a normal direction relative to the multi-layer printed circuit board; coupling a Time Domain Reflectometer (TDR) to the conductive line and the conductive reference surface so as to form a signal transmission line between the conductive line and the conductive reference surface; and sending a pulsed signal into the conductive line through the TDR so as to measure characteristic impedance of the signal transmission line.

According to another aspect of this invention, there is provided a multi-layer printed circuit board comprising: a plurality of conductive layers; a plurality of dielectric layers disposed alternately with the conductive layers; and a detecting unit including a conductive line, a conductive reference surface, and a through-hole that are respectively defined on three adjacent ones of the conductive layers. The conductive line, the conductive reference surface, and the through-hole are aligned in a normal direction relative to the multi-layer printed circuit board.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is a fragmentary schematic view of a conventional six-layer printed circuit board;

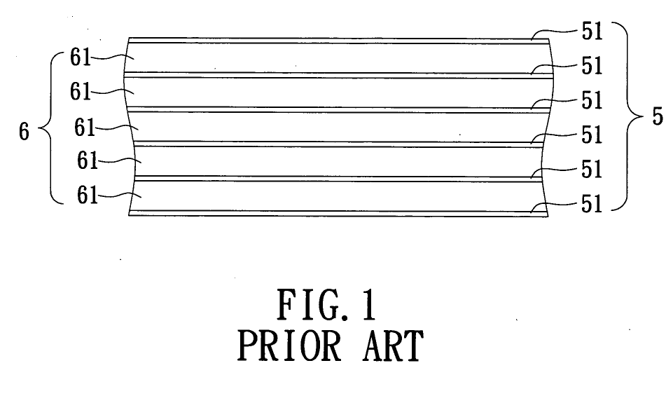

FIG. 2 is a fragmentary exploded perspective view of a conventional printed circuit board having detecting means for detecting errors in laminating order;

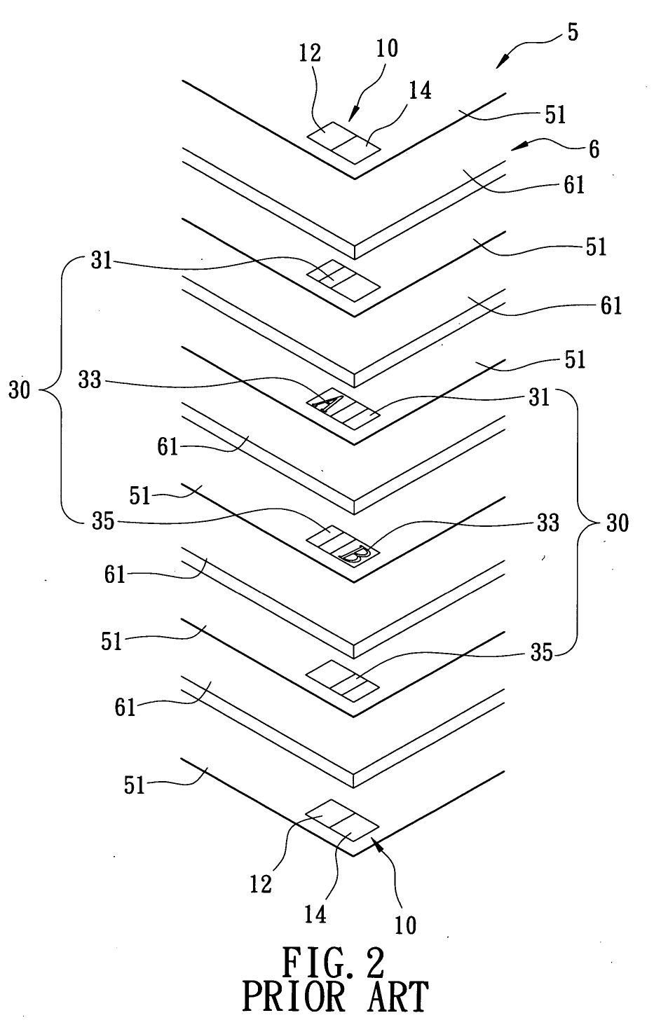

FIG. 3 is a top view showing observed detecting marks viewed from windows of the detecting means of FIG. 2 when a correct laminating order is achieved;

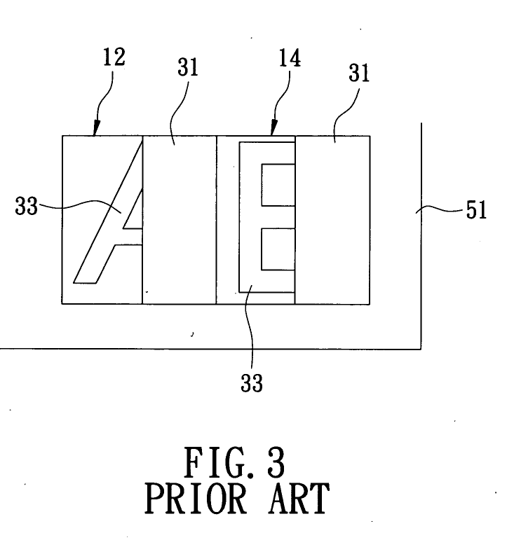

FIG. 4 is a fragmentary exploded perspective view of the first preferred embodiment of a four-layer printed circuit board having a detecting unit according to this invention;

FIG. 5 is a fragmentary schematic view of a Surface Microstrip model showing the relationship among a conductive line, a conductive reference surface, and a dielectric layer in a state where the conductive line is disposed on an uppermost conductive layer of a multi-layer printed circuit board of the preferred embodiment according to this invention;

FIG. 6 is a fragmentary schematic view of an Embedded Microstrip model showing the relationship among a conductive line, a conductive reference surface, and two dielectric layers in a state where the conductive line is disposed on an intermediate conductive layer of a multi-layer printed circuit board of the preferred embodiment according to this invention;

FIG. 7 is a fragmentary schematic view of an Offset Stripline model showing the relationship among a conductive line, two conductive reference surfaces, and two dielectric layers in a state where the conductive line is disposed on an intermediate conductive layer of a multi-layer printed circuit board of the preferred embodiment according to this invention;

FIG. 8 is a fragmentary exploded perspective view of the second preferred embodiment of a six-layer printed circuit board having two detecting units according to this invention;

FIG. 9 is a fragmentary exploded perspective view of a modification of the second preferred embodiment of a six-layer printed circuit board having two detecting units according to this invention;

FIG. 10 is a fragmentary exploded perspective view of the third preferred embodiment of an eight-layer printed circuit board having three detecting units according to this invention; and

FIG. 11 is a fragmentary exploded perspective view of a modification of the third preferred embodiment of an eight-layer printed circuit board having three detecting units according to this invention.

### DETAILED DESCRIPTION OF THE PREFERRED EMBODIMENTS

Before the present invention is described in greater detail, it should be noted that same reference numerals have been used to denote like elements throughout the specification.

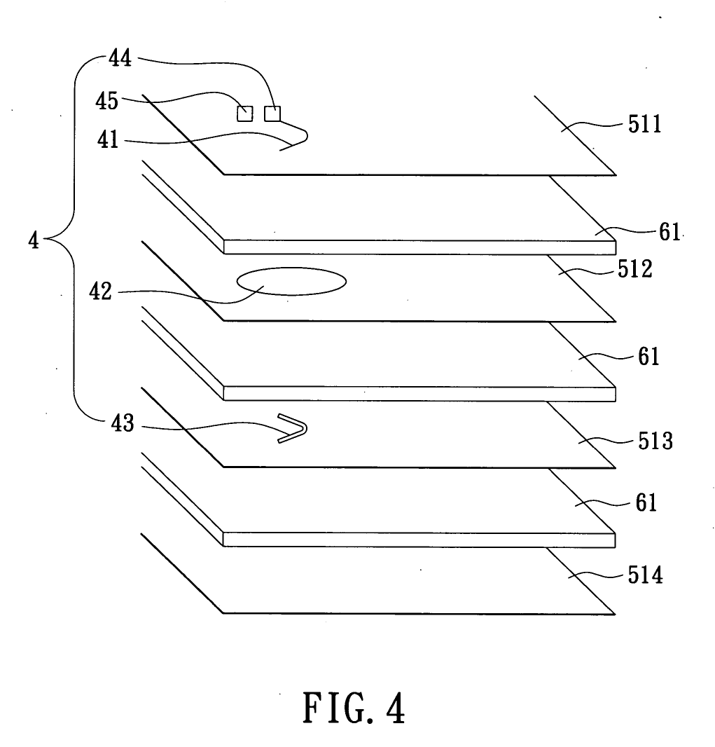

Referring to FIG. 4, the first preferred embodiment of a multi-layer printed circuit board according to the present invention is shown to include four conductive layers, three dielectric layers 61 disposed alternately with the four conductive layers, and a detecting unit 4. The four conductive layers are numbered as first conductive layer 511, second conductive layer 512, third conductive layer 513, and fourth conductive layer 514, which are stacked from top to bottom in this sequence. The detecting unit 4 includes a conductive line 41 defined on the first conductive layer 511, a conductive reference surface 42 defined on the second conductive layer 512, and a through-hole 43 defined on the third conductive layer 513. The conductive line 41, the conductive reference surface 42, and the through-hole 43 are aligned in a normal direction relative to the multi-layer printed circuit board. The conductive line 41 and the conductive reference surface 42 cooperate to define a signal transmission line therebetween.

In this invention, characteristic impedance of the signal transmission line is measured using a Time Domain Reflectometer (TDR, not shown). The TDR determines a change in the characteristic impedance of a conductor by sending an electrical pulsed signal into the conductor, and subsequently examining the pulse reflected by the conductor. During measurement, the TDR is coupled to the conductive line 41 and the conductive reference surface 42, and sends a pulsed signal that passes through the conductive line 41 and one of the dielectric layers 61 to the conductive reference surface 42 so as to obtain characteristic impedance of the signal transmission line. Since the conductive reference surface 42 is used to receive the pulsed signal transmitted from the conductive line 41 and through said one of the dielectric layers 61, the conductive reference surface 42 should have a size sufficient to cover the first conductive line 41.

Formation of the through-hole 43 in the third conductive layer 513 permits passage of the pulsed signal therethrough toward the conductive reference surface 42 when the third conductive layer 513 is disposed between the first and second conductive layers 511, 512. As such, the inclusion of the detecting unit 4 in the multi-layer printed circuit board permits detection of errors in the laminating order of the conductive layers. Preferably, the through-hole 43 has a size sufficient to cover the conductive line so as to ensure transmission of the entire pulsed signal to the conductive reference surface 42.

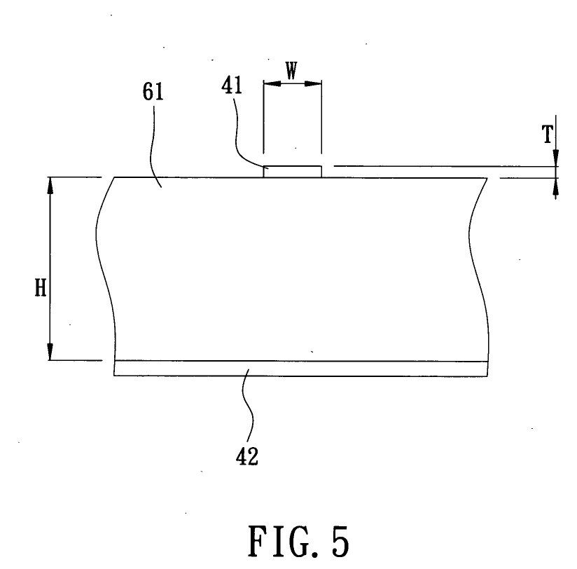

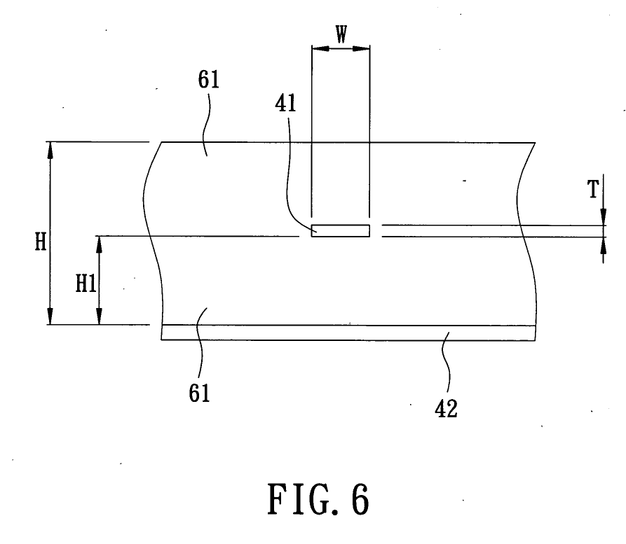

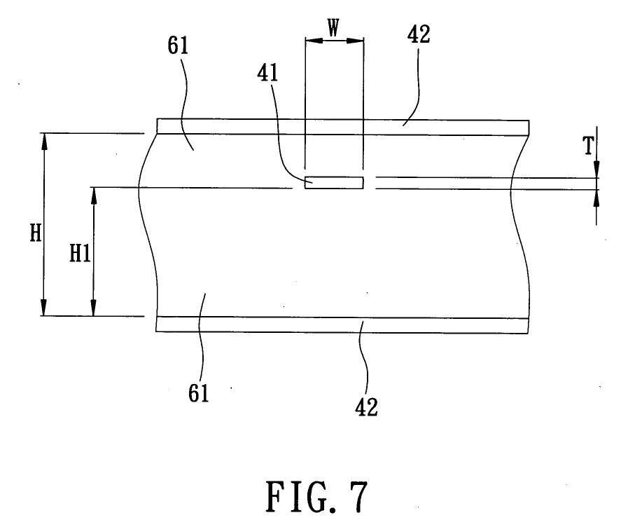

Moreover, measurement of the change in characteristic impedance will vary based on the location of the conductive line 41. When the conductive line 41 is disposed on one of the outermost conductive layers, i.e., the first or fourth conductive layers 511, 514, characteristic impedance is measured using the Surface Microstrip model (see FIG. 5). That is, the characteristic impedance is a function of the width (W) and thickness (T) of the conductive line 41 and the thickness (H) and dielectric constant (εᵣ) of the dielectric layer 61 between the conductive line 41 and the conductive reference surface 42. When the conductive line 41 is disposed on one of the intermediate conductive layers, i.e., the conductive layers 512, 513, the characteristic impedance is measured using the Embedded Microstrip model (see FIG. 6) or the Offset Stripline model (see FIG. 7). That is, in these two models, characteristic impedance is a function of the width (W) and thickness (T) of the conductive line 41, the thickness (H) and dielectric constant (εᵣ) of the dielectric layer(s) 61, and the distance (Hi) between the conductive line 41 and the conductive reference surface 42. The difference between the two models is that, in the Offset Stripline model, there are two of the conductive reference surfaces 42 disposed respectively at two sides of the dielectric layer 61 (see FIG. 7).

When the laminating order of the conductive layers is changed, the thickness (H) of the dielectric layer 61 and the distance (Hl) between the conductive line 41 and the conductive reference surface 42 will change accordingly, thereby resulting in drift in the characteristic impedance.

FIGS. 4, 8 to 11 illustrate the preferred embodiments of the multi-layer printed circuit board according to this invention.

Referring to FIG. 4, characteristic impedance is measured using the Surface Microstrip model. If the second conductive layer 512 is exchanged with the third conductive layer 513, the thickness (H) of the dielectric layer 61 between the conductive line 41 and the conductive reference surface 42 is increased, thereby resulting in an increase in characteristic impedance.

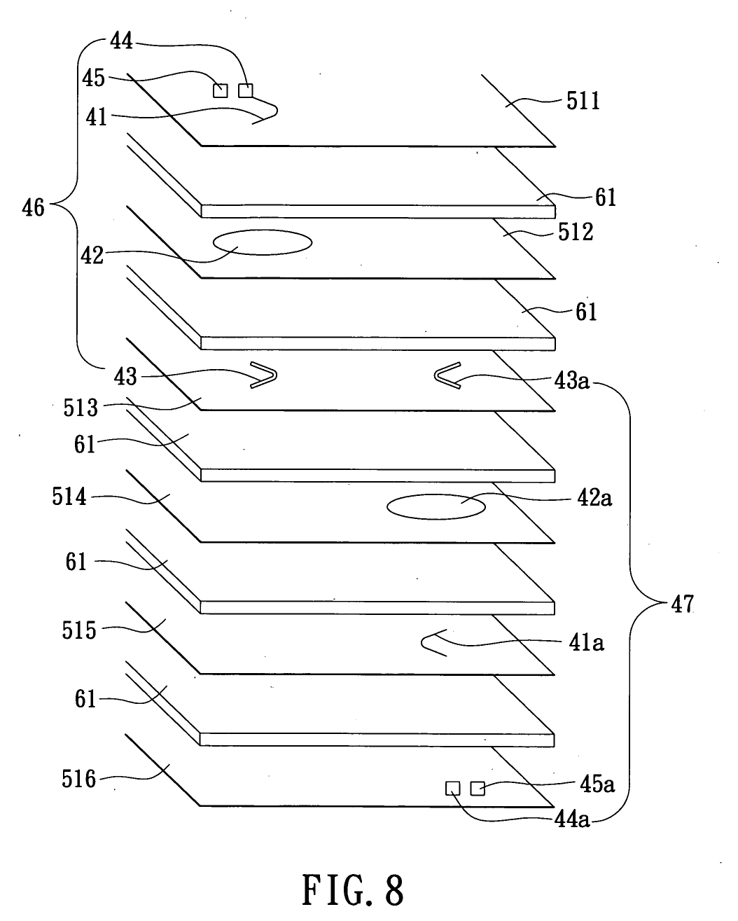

FIG. 8 illustrates the second preferred embodiment of a six-layer printed circuit board having two detecting units according to this invention. In this embodiment, the printed circuit board includes six conductive layers, five dielectric layers 61 disposed alternately with the six conductive layers, and first and second detecting units 46, 47. The six conductive layers are numbered as first, second, third, fourth, fifth, and sixth conductive layers 511, 512, 513, 514, 515, and 516, which are stacked from top to bottom in this sequence. The first detecting unit 46 includes a first conductive line 41 defined on the first conductive layer 511, a first conductive reference surface 42 defined on the second conductive layer 512, and a first through-hole 43 defined on the third conductive layer 513. The first conductive line 41, the first conductive reference surface 42, and the first through-hole 43 are aligned in the normal direction relative to the multi-layer printed circuit board. The second detecting unit 47 includes a second conductive line41a defined on the fifth conductive layer 515, a second conductive reference surface 42a defined on the fourth conductive layer 514, and a second through-hole 43a defined on the third conductive layer 513. The second conductive line 41a, the second conductive reference surface 42a, and the second through-hole 43a are aligned in the normal direction relative to the multi-layer printed circuit board. It is noted that, in this preferred embodiment, the first through-hole 43 and the second through-hole 43a are offset from each other.

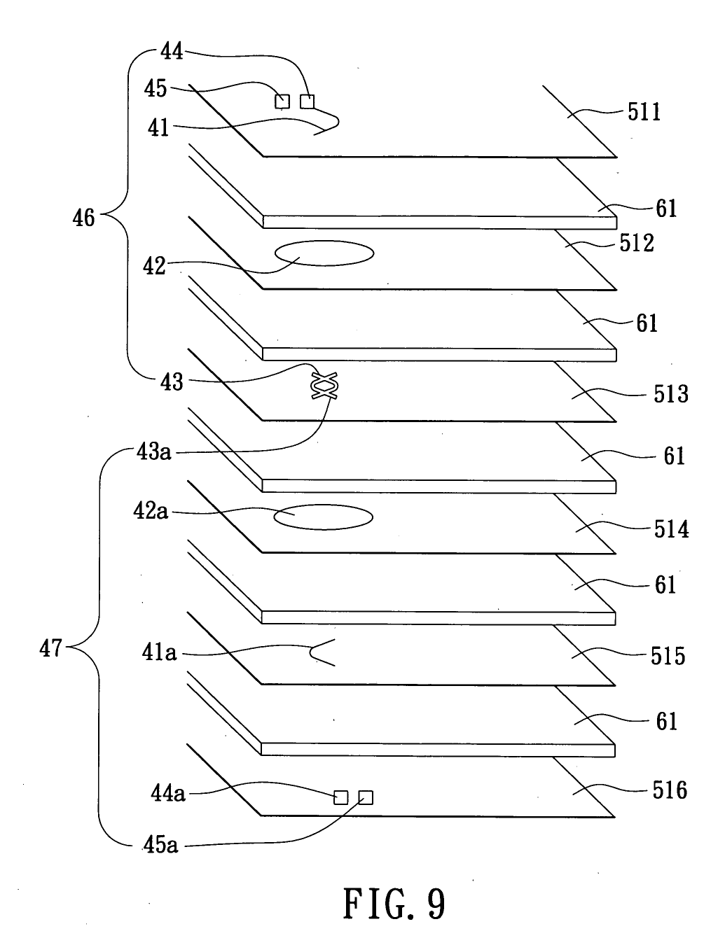

Alternatively, the first through-hole 43 and the second through-hole 43a can be disposed to partly overlap each other, as best shown in FIG. 9.

In FIGS. 8 and 9, the first and second conductive reference surfaces 42, 42a have sizes that are sufficient to cover the first and second conductive lines 41, 41a, respectively. The first and second through-holes 43, 43a have sizes that are sufficient to cover the first and second conductive lines 41, 41a, respectively.

In either of FIGS. 8 and 9, characteristic impedance of the second detecting unit 47 is measured using the Embedded Microstrip model. If the third conductive layer 513 is exchanged with the fourth conductive layer 514, the distance (H1) between the second conductive line 41a and the second conductive reference surface 42a is increased, thereby resulting in an increase in the characteristic impedance.

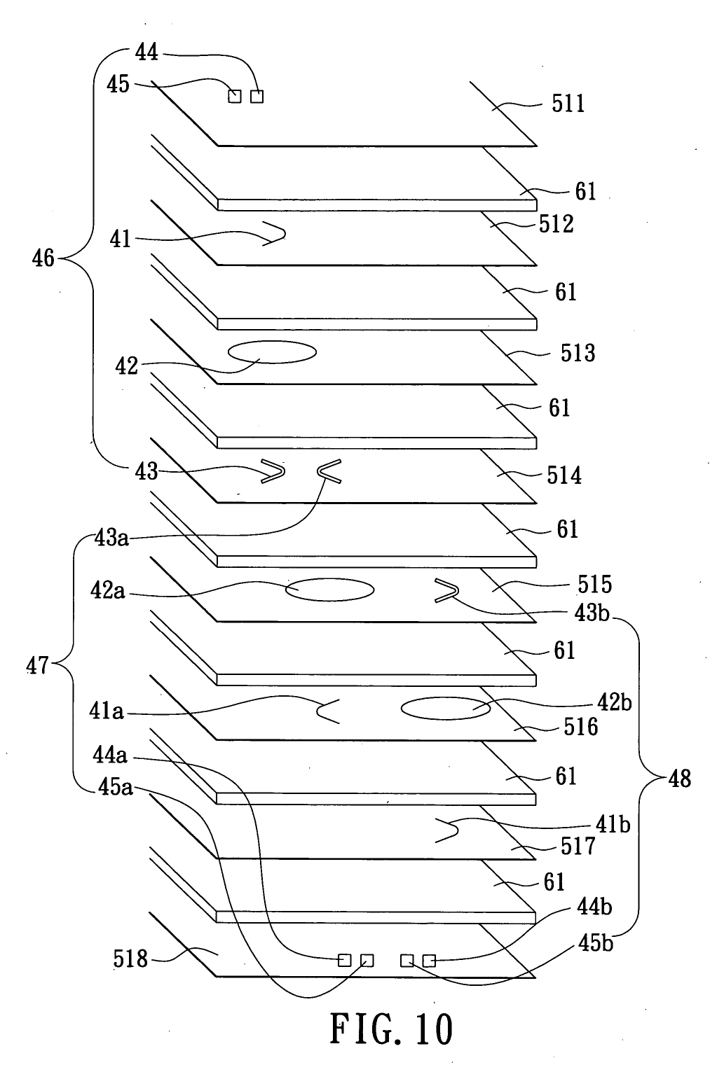

FIG. 10 illustrates the third preferred embodiment of an eight-layer printed circuit board having three detecting units 46, 47, 48 according to this invention. In this embodiment, the printed circuit board includes eight conductive layers, seven dielectric layers 61 disposed alternately with the eight conductive layers, and first, second, and third detecting units 46, 4.7, 48. The eight conductive layers are numbered as first, second, third, fourth, fifth, sixth, seventh, and eighth conductive layers 511, 512, 513, 514, 515, 516, 517, 518, which are stacked from top to bottom in this sequence. The first detecting unit 46 includes a first conductive line 41 defined on the second conductive layer 512, a first conductive reference surface 42 defined on the third conductive layer 513, and a first through-hole 43 defined on the fourth conductive layer 514. The first conductive line 41, the first conductive reference surface 42, and the first through-hole 43 are aligned in the normal direction relative to the multi-layer printed circuit board. The second detecting unit 47 includes a second conductive line 41a defined on the sixth conductive layer 516, a second conductive reference surface 42a defined on the fifth conductive layer 515, and a second through-hole 43a defined on the fourth conductive layer 514. The second conductive line 41a, the second conductive reference surface 42a, and the second through-hole 43a are aligned in the normal direction relative to the multi-layer printed circuit board. The third detecting unit 48 includes a third conductive line 41b defined on the seventh conductive layer 517, a third conductive reference surface 42b defined on the sixth conductive layer 516, and a third through-hole 43b defined on the fifth conductive layer 515. The third conductive line 41b, the third conductive reference surface 42b, and the third through-hole 43b are aligned in the normal direction relative to the multi-layer printed circuit board. It is noted that, in this preferred embodiment, the first through-hole 43, the second through-hole 43a, and the third through-hole 43b are offset from one another.

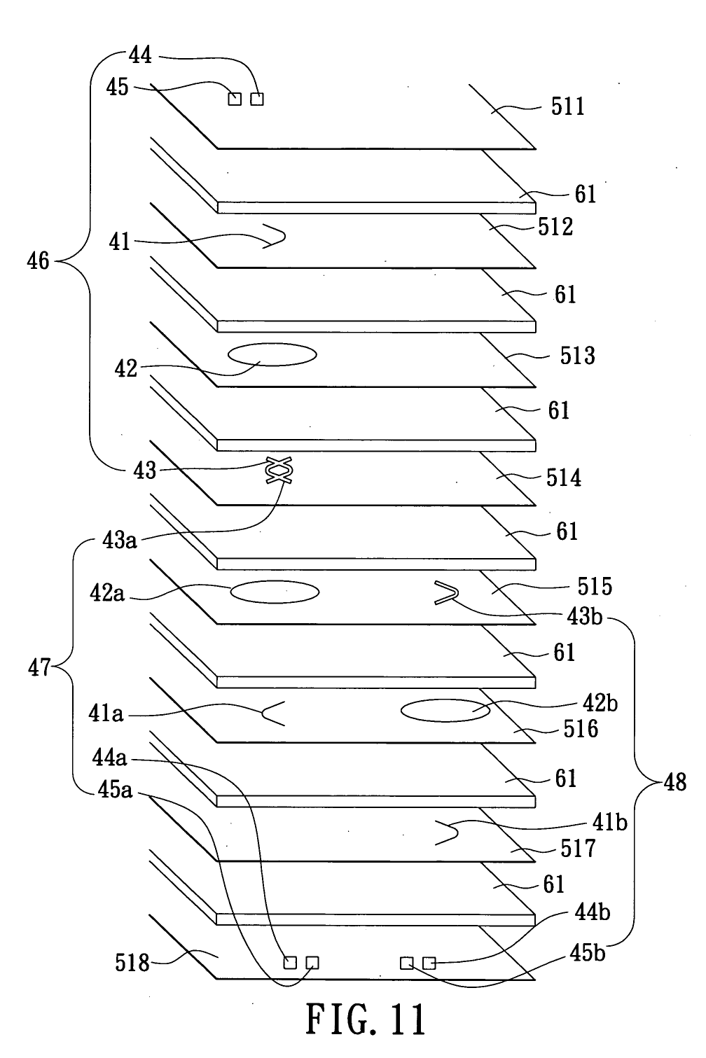

Alternatively, the first through-hole 43 and the second through-hole 43a can be disposed to partly overlap each other, as best shown in FIG. 11.

In FIGS. 10 and 11, the first, second, and third conductive reference surfaces 42, 42a, 42b have sizes that are sufficient to cover the first, second, and third conductive lines 41, 41a, 41b, respectively. The first, second, and third through-holes 43, 43a, 43b have sizes that are sufficient to cover the first, second, and third conductive lines 41, 41a, 41b, respectively.

In either of FIGS. 10 and 11, when the second conductive layer 512 is exchanged with the third conductive layer 513, characteristic impedance of the first detecting unit 46 is measured using Offset Stripline model shown in FIG. 7. Under this laminating order, the thickness (H) of the dielectric layer(s) 61 between the first and second conductive reference surfaces 42, 42a is increased, thereby resulting in an increase in characteristic impedance.

In the preferred embodiments of this invention, the laminating order is in the order of the conductive line, the conductive reference surface, and the through-hole. However, the laminating order is not limited to these embodiments.

In addition, each of the detecting units 4, 46, 47, 48 further includes two contact points 44, 44a, 44b, 45, 45a, 45b to enable connection of the TDR to the conductive line 41, 41a, 41b and the conductive reference surface 42, 42a, 42b (see FIGS. 4, 8-11).

According to the present invention, errors in the laminatingorderof layersof a multi-layerprinted circuit board can be determined by measuring the change in characteristic impedance of the transmission line using the TDR. Therefore, the observation problem commonly encountered in the prior art can be avoided.

While the present invention has been described in connection with what is considered the most practical and preferred embodiments, it is understood that this invention is not limited to the disclosed embodiments but is intended to cover various arrangements included within the spirit and scope of the broadest interpretation and equivalent arrangements.

What is claimed is:

1. A method for detecting errors in laminating order of layers of a multi-layer printed circuit board, comprising:
preparing a multi-layer printed circuit board including a plurality of conductive layers and a plurality of dielectric layers disposed alternately with the conductive layers;
defining a first conductive line, a first conductive reference surface, and a first through-hole respectively on three adjacent ones of the conductive layers in such a manner that the first conductive line, the first conductive reference surface, and the first through-hole are aligned in a normal direction relative to the multi-layer printed circuit board;
coupling a Time Domain Reflectometer (TDR) to the first conductive line and the first conductive reference surface so as to form a first signal transmission line between the first conductive line and the first conductive reference surface; and
sending a pulsed signal into the first conductive line through the TDR so as to measure characteristic impedance of the first signal transmission line.

2. The method of claim 1, wherein the first conductive reference surface has a size sufficient to cover the first conductive line.

3. The method of claim 2, wherein the first through-hole has a size sufficient to cover the first conductive line.

4. The method of claim 1, wherein the first conductive reference surface is disposed between the first conductive line and the first through-hole in the normal direction.

5. A multi-layer printed circuit board comprising:
a plurality of conductive layers;
a plurality of dielectric layers disposed alternately with said conductive layers; and
a first detecting unit including a first conductive line, a first conductive reference surface, and a first through-hole that are respectively defined on three adjacent ones of the conductive layers;
wherein said first conductive line, said first conductive reference surface, and said first through-hole are aligned in a normal direction relative to said multi-layer printed circuit board.

6. The multi-layer printed circuit board of claim 5, wherein said first conductive reference surface has a size sufficient to cover said first conductive line.

7. The multi-layer printed circuit board of claim 6, wherein said first through-hole has a size sufficient to cover said first conductive line.

8. The multi-layer printed circuit board of claim 5, wherein said first conductive reference surface is disposed between said first conductive line and said first through-hole in the normal direction.

9. The multi-layer printed circuit board of claim 5, wherein said conductive layers include first, second, third, fourth, fifth, and sixth conductive layers which are stacked in sequence in the normal direction, said first conductive line being defined on said first conductive layer, said first conductive reference surface being defined on said second conductive layer, said first through-hole being defined on said third conductive layer.

10. The multi-layer printed circuit board of claim 9, further comprising a second detecting unit including a second conductive line defined on said fifth conductive layer, a second conductive reference surface defined on said fourth conductive layer, and a second through-hole defined on said third conductive layer, said second conductive line, said second conductive reference surface, and said second through-hole being aligned in the normal direction relative to said multi-layer printed circuit board.

11. The multi-layer printed circuit board of claim 10, wherein said second conductive reference surface has a size sufficient to cover said second conductive line.

12. The multi-layer printed circuit board of claim 11, wherein said second through-hole has a size sufficient to cover said second conductive line.

13. The multi-layer printed circuit board of claim 10, wherein said first through-hole and said second through-hole are offset from each other.

14. The multi-layer printed circuit board of claim 10, wherein said first through-hole and said second through-hole partly overlap each other.

15. The multi-layer printed circuit board of claim 5, wherein said conductive layers include first, second, third, fourth, fifth, sixth, seventh, and eighth conductive layers which are stacked in sequence in the normal direction, said first conductive line being defined on said second conductive layer, said first conductive reference surface being defined on said third conductive layer, said first through-hole being defined on the fourth conductive layer.

16. The multi-layer printed circuit board of claim 15, further comprising a second detecting unit including a second conductive line defined on said sixth conductive layer, a second conductive reference surface defined on said fifth conductive layer, and a second through-hole defined on said fourth conductive layer, said second conductive line, said second conductive reference surface, and said second through-hole being aligned in the normal direction.

17. The multi-layer printed circuit board of claim 16, further comprising a third detecting unit including a third conductive line defined on said seventh conductive layer, a third conductive reference surface defined on said sixth conductive layer, and a third through-hole defined on said fifth conductive layer, said third conductive line, said third conductive reference surface, and said third through-hole being aligned in the normal direction.

18. The multi-layer printed circuit board of claim 17, wherein said second and third conductive reference surface shave sizes that are sufficient to cover said second and third conductive lines, respectively.

19. The multi-layer printed circuit board of claim 18, wherein said second and third through-holes have sizes that are sufficient to cover said second and third conductive lines, respectively.

20. The multi-layer printed circuit board of claim 17, wherein said first through-hole, said second through-hole, and said third through-hole are offset from each other.

21. The multi-layer printed circuit board of claim 17, wherein said first through-hole and said second through-hole partly overlap each other.
